(19) United States
(12) Patent Application Publication
(10) Pub. No.: US 2014/0260812 A1
(43) Pub. Date: Sep. 18, 2014

(54) Hammer with Buffer Assembly

(71) Applicant: Hsiu-Hua CHANG, (US)

(72) Inventor: Hsiu-Hua CHANG, Taichung City (TW)

(21) Appl. No.: 13/830,803

(22) Filed: Mar. 14, 2013

(51) Int. Cl. B25D 1/12

(52) U.S. Cl. CPC B25D 1/12
USPC 81/22

(57) ABSTRACT

A hammer includes a head, a handle pivotally connected to the head, and a buffer assembly arranged between the head and the handle. The buffer assembly includes a compression spring and a sheath. The compression spring is compressed between the head and the handle. The sheath is used to protectively cover the compression spring.

### BACKGROUND OF INVENTION

1. Field of Invention

The present invention relates to a hammer and, more particularly, to a hammer with a buffer assembly.

2. Related Prior Art

A conventional hammer includes a head secured to a handle. A user can hold the handle to swing to the head to hammer a nail or work piece. As the user exert a strong force on the pin or work piece with the hammer, the nail or work piece a strong reaction force on the user's hand via the hammer. After using the hammer on the work piece for a period of time, the user inevitably absorbs a lot of shocks and suffers repeated injuries that would accumulate and lead to an occupational disease.

In co-pending U.S. Patent Application Publication No. 20120186399, there is disclosed a hammer 10 including a head 20, a handle 30 pivotally connected to the handle 20, and a buffer assembly 50 provided between the head 20 and the handle 30. The buffer assembly 50 includes a compression spring 51, a pin 52 and a cap 53. The compression spring 51 is compressed between an enlarged end of the pin 52 and the cap 53. The enlarged end of the pin 52 is placed against the head 20. The cap 53 is placed against the handle 30. Thus, socks caused in an operation are buffered by the buffer assembly 50. However, the compression spring 51 and the pin 52 might get contaminated by dirt or liquid. Such dirt might wear out the compression spring 51 and the pin 52. Such liquid might cause the compression spring 51 and the pin 52 to rust than expected.

Therefore, the present invention is intended to obviate or at least alleviate the problems encountered in prior art.

### SUMMARY OF INVENTION

It is the primary objective of the present invention to provide a hammer with a durable buffer assembly.

To achieve the foregoing objective, the hammer includes a head and a handle pivotally connected to the head. The buffer assembly includes a compression spring and a sheath. The compression spring is compressed between the head and the handle. The sheath is used to protectively cover the compression spring.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a hammer according to the preferred embodiment of the present invention;

FIG. 2 is a cross-sectional view of the hammer shown in FIG. 1; and

FIG. 3 is an enlarged partial view of the hammer shown in FIG. 2.

### DETAILED DESCRIPTION OF PREFERRED EMBODIMENT

Referring to FIGS. 1 to 3, there is shown a hammer 10 according to the preferred embodiment of the present invention. The hammer 10 includes a head 20, a handle 30, a pivot assembly 40 for pivotally connecting the head 20 to the handle 30, and a buffer assembly 50 arranged between the head 20 and the handle 30.

The head 20 is made of steel or any other proper sort of metal. The head 20 has a bell 21, a claw 22, a lug 23, two depressions, and two stops 241 and 251. The bell 21 extends opposite to the claw 22. The lug 23 extends from a lower face of the head 20. The lug 23 includes an aperture 231 defined in a lower portion thereof and a cutout 232 defined in a rear edge thereof. The first depression is defined in a side of the lug 23 and the second depression is defined in an opposite side of the lug 23. The stop 241 is formed in the vicinity of the first depression and the stop 251 is formed in the vicinity of the second depression.

The handle 30 includes a grip 31 and three two plates 32, 33 and 34. The plates 32, 33 and 34 extend from an upper end of the grip 31. The plate 32 is an arched plate while the plates 33 and 34 are flat plates. The plate 32 extends to the plate 33 from the plate 34. The plates 32, 33 and 34 together define a chamber 35. The plate 33 includes an aperture 331 corresponding to the aperture 231 and an upper edge 332 corresponding to the stop 241. The plate 34 includes an aperture 341 corresponding to the aperture 231 and an upper edge 342 corresponding to the stop 251. The apertures 331 and 341 are preferably countersink holes.

The pivot assembly 40 includes a screw 41 and a nut 42. The screw 41 can be engaged with the nut 42.

The buffer assembly 50 includes a compression spring 51, a pin 52, a cap 53 and a sheath 54. The pin 52 includes an enlarged end. The pin 52 is inserted in the cap 53 through the compression spring 51. The compression spring 51 is compressed between the enlarged end of the pin 52 and the cap 53. The sheath 54 is placed around the pin 52, compression spring 51 and the cap 53. Preferably, the compression spring 51, the pin 52, the cap 53 and the sheath 54 are made of metal. However, the cap 53 and the sheath 54 may be made of plastics or rubber for example.

In assembly, the lug 23 of the head 20 is inserted in the chamber 35 of the handle 30. The plates 33 and 34 are placed in the depressions.

The screw 41 is inserted in the apertures 331 and 231 and the nut 42 is inserted in the apertures 341 and 231 before the screw 41 is engaged with the nut 42. Thus, the head 20 is pivotally connected to the handle 30 by the pivot assembly 40.

The buffer assembly 50 is placed in the cutout 232 of the head 20. The enlarged end of the compression spring 51 is placed against a wall of the cutout 232, i.e., a portion of the head 20 in the cutout 232. The cap 53 is placed against the plate 32. The pin 52 is used to stabilize the compression spring 51 when the compression spring 51 is compressed. However, the pin 52 may be saved.

In a normal state, the upper edge 342 of the plate 34 is placed against the stop 241 of the head 20 and the upper edge 332 of the plate 33 is placed against the stop 251. In addition, the lug 23 of the head 20 is spaced from the plate 32 of the handle 30 by a certain buffering distance.

When a user holds the grip 31 to operate the handle 30 to swing the head 20 to hammer a nail or work piece, a reaction force will compress the compression spring 51 until the lug 23 touches the plate 32. In the operation, the compression spring 51 provides a buffering effect to greatly decay the reaction force to minimize the possible injury to the user's hand and ensure health of the user. When the head 20 leaves the work piece, the compression spring 51 restores to its original state.

The sheath 54 protects the compression spring 51 and the pin 52 from dirt or liquid. Thus, there is no dirt to wear out the compression spring 51 and the pin 52, and there is no liquid to cause the compression spring 51 and the pin 52 to rust than expected.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A hammer including a head, a handle pivotally connected to the head, and a buffer assembly including a compression spring compressed between the head and the handle and a sheath for protectively covering the compression spring.

2. The hammer according to in claim 1, wherein the buffer assembly includes a cap for receiving an end of the compression spring, wherein the compression spring is compressed between the head and the cap that is placed against the handle.

3. The hammer according to in claim 2, wherein the buffer assembly includes a pin partially inserted in the compression spring, wherein the compression spring is compressed between the cap and an enlarged end of the pin that is placed against the head.

4. The hammer according to in claim 3, wherein the head is formed with a lug, wherein the handle includes two lateral plates pivotally connected to the lug and a rear plate extending between the lateral plates, wherein the pin is placed against the lug while the cap is placed against the rear plate.

5. The hammer according to in claim 4, wherein the lug is spaced from the rear plate by a certain buffering distance.

6. The hammer according to in claim 4, wherein the lug includes a cutout for receiving the buffer assembly.

7. The hammer according to in claim 4, including a pivot assembly for pivotally connecting the lug to the lateral plates.

8. The hammer according to in claim 7, wherein the lug includes an aperture defined therein, wherein each of the lateral plates includes an aperture defined therein, wherein the pivot assembly includes a screw driven in the aperture of the lug and the apertures of the lateral plates and a nut engaged with the screw.

9. The hammer according to in claim 4, wherein the head includes two stops, wherein each of the lateral plates includes an upper edge for contact with a corresponding one of the stops for limit the pivoting of the head relative to the handle.
